(19) United States
(12) Patent Application Publication
(10) Pub. No.: US 2010/0156906 A1
(43) Pub. Date: Jun. 24, 2010

(54) Shot generation from previsualization of a physical environment

(76) Inventors: David Montgomery, Half Moon Bay, CA (US); Phil Gorrow, Half Moon Bay, CA (US); Chad M. Nelson, Oakland, CA (US)

Correspondence Address: Innovation Counsel LLP, 21771 Stevens Creek Blvd, Ste. 200A, Cupertino, CA, 95014, US

(21) Appl. No.: 12/317,154

(22) Filed: Dec. 19, 2008

(51) Int. Cl. G06T 15/10

(52) U.S. Cl. 345/427

(57) ABSTRACT

Methods and apparatus, including computer program products, for generating a shot list for a physical environment based on fields of view of virtual cameras. A 3D virtual environment is created by texture mapping one or more photographs of the physical environment onto a representation of the physical environment's 3D topography. One or more virtual cameras is placed in relation to the virtual environment so that each virtual camera's field of view captures a portion of the virtual environment. Virtual camera fields of view are presented and input accepted to modify one or more parameters of the virtual cameras. The fields of view of the virtual cameras are updated based on the modifying.

### BACKGROUND

The present disclosure relates to using photographs in computer simulations, including planning the utilization of photographs in computer simulations.

Computer games and other types of simulations recreate real world environments such as baseball diamonds, race tracks, air flight, and golf courses through three dimensional (3D) computer generated graphics. However, such graphics can typically create unnatural visual artifacts such as repeating patterns which detract from the intended realism of the imagery. Some computer games may use a photograph of an actual location as a background, such as a mountains, with computer generated graphics rendered in the foreground. However, there may not be any interaction between the computer generated graphics and the terrain represented by the photograph.

A number of challenges may arise in capturing the photographs necessary or desired for a particular computer game using photographs in its user interface. The course to be photographed may need to be reserved in advance of the photography, limiting the time in which the photography is to be completed. When the real world course is outdoors, it may be desirable to ensure consistency among the photographs of a given course. For example, as weather systems move in and out, and as the sun changes position in the sky, photographs of the same course, taken at different times or on different days, may appear out-of-synch, betraying the contemporaneousness of the scene represented by the photographic images. Additionally, the hiring of photographers, processing of photographs, and other infrastructure related to the photography of the course can be costly. These are among the factors that make it desirable for the photography of a course to be completed efficiently. Achieving this goal requires careful planning by the game designer and photographers.

Accurately planning a photoshoot for a computer game may involve additional complexities. For example, in order to choose the location and nature of the photographs to be taken, the game design team may need to have extensive familiarity with the course. In some instances, this can be achieved by physically visiting the course and planning the shoot. Availability and access, among other considerations, can make this approach impractical and inefficient. Additionally, planning the shoot without previewing the images of the course as they would be captured by a camera, can reveal unintended deficiencies in the photoshoot plan. For instance, the originally-planned elevation, angle, or other characteristic of a planned photograph may result in an actual photograph inadequately capturing the scene envisioned by the computer game designer. Such flaws may interrupt the efficiency of a photoshoot or may require remedying the flaws with additional, substitute shoots.

### SUMMARY

This specification describes a number of methods, systems, and programs that enable users to pre-visualize a physical environment by creating a 3D virtual environment of a physical environment, placing one or more virtual cameras in relation to the virtual environment, and generating a shot list based on the fields of view of the virtual cameras. In some implementations, users can modify the fields of view of the virtual cameras through inputs to modify one or more parameters of the virtual cameras.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-D illustrate example views of a graphical user interface for a computer golf game that incorporates photographs of an actual golf course into the game play.

FIG. 2A illustrates a map for example placement of cameras in a physical environment.

FIGS. 2B-C illustrate a second map for example placement of cameras in a physical environment.

FIG. 3A illustrates a real world camera's field of view of a physical environment.

FIG. 3B illustrates a virtual camera's field of view of the physical environment of FIG. 3A.

FIG. 4 is a flow diagram of an example technique for developing a shot list using a pre-visualization tool.

FIGS. 5A-D illustrate an example representation of texture mapping a 2D image of a real-world terrain onto a height map of a real-world terrain.

FIGS. 6A-B illustrate an example of a shot list generated with the aid of the pre-visualization tool.

FIGS. 7A-D illustrate screenshots of an example user interface of the pre-visualization tool utilizing virtual cameras.

FIG. 8 illustrates an automatically-generated course grid.

FIG. 9 illustrates a field of view of a virtual camera incorporating an extraneous graphic.

FIG. 10 is a flow diagram of an example technique for incorporating a virtual environment into a game simulation.

FIG. 11A illustrates an example interactive computer game system.

FIG. 11B illustrates a second example of an interactive computer game system.

FIG. 11C illustrates a third example of an interactive computer game system.

FIG. 11D illustrates a schematic diagram of an example client computing device in an interactive computer game system.

FIG. 11E illustrates a schematic diagram of an example server device in an interactive computer game system.

FIG. 12 illustrates an example pre-visualization system.

FIG. 13 illustrates an example game simulation system.

Like reference numbers and designations in the various drawings indicate like elements.

### DETAILED DESCRIPTION

Photographs can be used to build the virtual universe of a computer game or simulation, creating a more life-like presentation for the user. Capturing this set of photographs for use in a computer game can require detailed organization and planning in advance, by the game designers. A pre-visualization tool can be utilized employing a virtual model of the environment to be photographed as well as virtual cameras to simulate one or more real-life photoshoots for capturing the set of photographs. This simulated, virtual photoshoot can allow the game designer to generate guidelines, or a shot list, for capturing the real life photographs corresponding to those captured in the simulated, virtual photoshoot.

Many computer games and other types of simulations include a virtual universe that players interact with in order to achieve one or more goals, such as shooting all of the “bad” guys or playing a hole of golf. Typical computer game genres include role-playing, first person shooter, third person shooter, sports, racing, fighting, action, strategy, music, and simulation. A computer game can incorporate a combination of two or more genres. Computer games are commonly available for different computer platforms such as workstations, personal computers, game consoles (e.g., Sony PlayStation and PlayStation Portable, Microsoft Xbox, Nintendo Wii, GameCube, and Game Boy), cellular telephones, portable media players, and other mobile devices. Computer games can be single player or multi-player. Some multiplayer games allow players connected via the Internet to interact in a common or shared virtual universe.

A virtual universe is the paradigm with which the user interacts when playing a computer game and can include representations of virtual environments, objects, characters, and associated state information. For instance, a virtual universe can include a virtual golf course, golfers, golf clubs and golf balls. The virtual objects and characters can interact with and respond to the virtual environment, as well as interact with and respond to other virtual objects and characters. A virtual universe and its virtual objects can change as users make selections, advance through the game, or achieve goals. For example, in action games, as users advance to higher game levels, typically the virtual universe is changed to model the new level and users are furnished with different virtual equipment, such as more powerful weapons.

Players typically interact with one or more virtual objects in a virtual universe, such as an avatar and virtual equipment, through a user interface. A user interface can accept input from all manner of input devices including, but not limited to, devices capable of receiving mouse input, trackball input, button presses, verbal commands, sounds, gestures, finger touches, eye movements, body movements, brain waves, other types of physiological sensors, and combinations of these. A click of a mouse button, for example, might cause a virtual golf club to swing and strike a virtual golf ball on a virtual golf course.

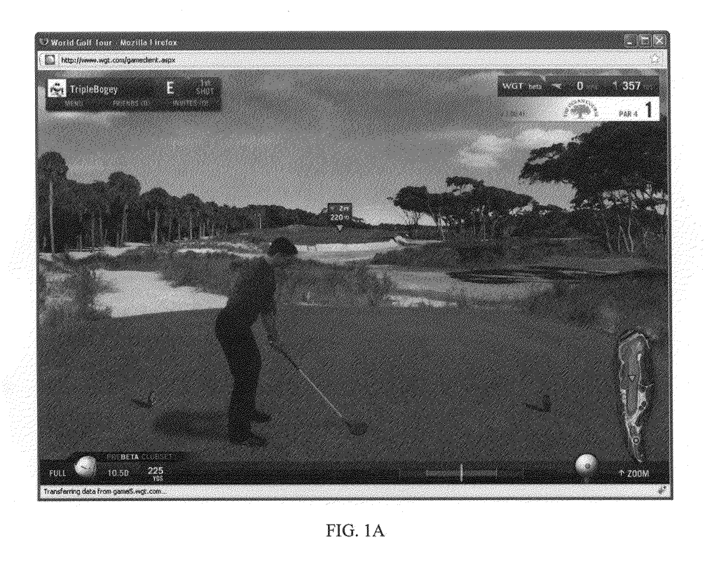

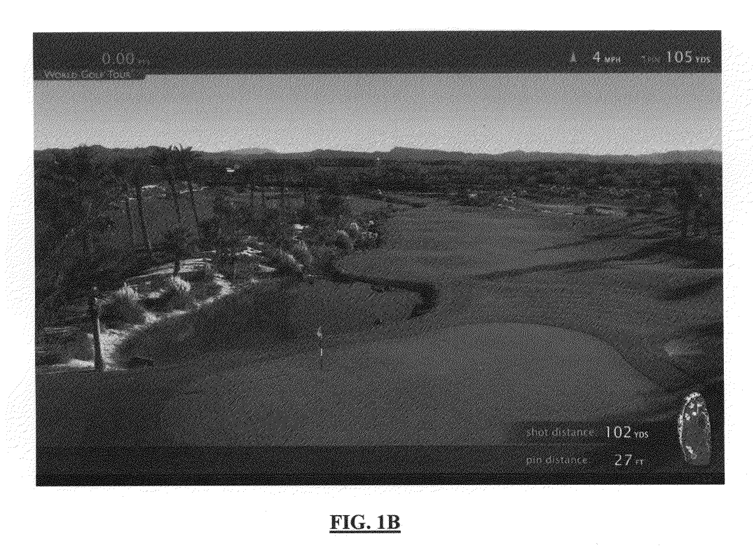

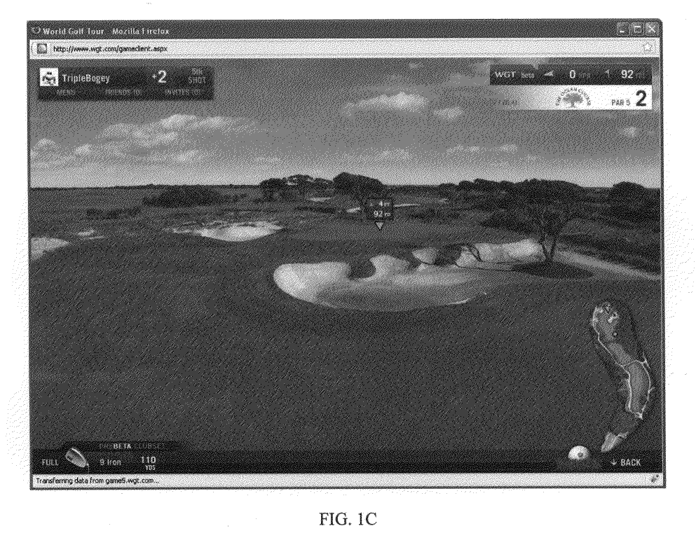

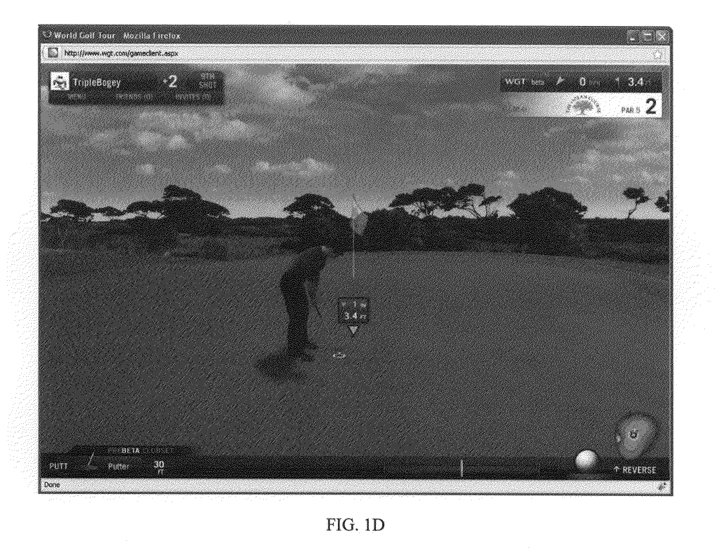

FIGS. 1A-D illustrate various screenshots of an example interactive electronic game. This particular, illustrated implementation is a golf simulation game. FIGS. 1A-D illustrate various fields of view of the game's virtual environment, capable of being presented to the game user. Each field of view incorporates an actual photograph of a real life course (or physical environment), in this case a golf course. A number of photographs may be incorporated of a single section of the course to present the desired portion of the virtual universe to the user. For example, in FIG. 1A a photograph of a golf course is presented from the view of a golfer standing in the tee box and looking down the fairway toward the hole, dogleg, etc. After the user drives the ball, through interaction with the game, it may be desirable to present the user with a view of the golf ball virtual object traveling toward its target. FIG. 1B illustrates the implementation of a photograph capturing the path of the ball near the landing spot of the ball with a view towards the avatar golfer 105. The computer game may provide for virtual objects to appear to interact with the photograph. For example, a golf ball virtual object may appear to roll or bounce down the course illustrated by the photograph, or splash into water illustrated in the photograph. FIG. 1C illustrates the presentment of a photograph of an overhead view of a hazard on the golf course, perhaps even the same hole as photographed in FIGS. 1A and B, in order to present the user with a dramatic view of the ball traveling into and appearing to interact with the hazard illustrated in the photograph. FIG. 1D illustrates the utilization of a photograph of a putting green, the photo having a narrower angle view in order to zoom in on the flag pin and present a field of view that is both appropriate to the events taking place in the game (putting) as well as visually attractive to the user.

The golf course game screenshots in FIGS. 1A-D were presented for illustrative purposes only. The number, style, and types of photographs that might be incorporated into an interactive game, as well as the motivation for these photographs, are as diverse and varied as the types and forms of interactive games capable of being contemplated. For example, 3D, stereo-paired photographs can be used in lieu of conventional 2D digital photographs in some implementations. Choices regarding the photographs will be, in large part, dependent on the type of game itself, including its genre, style, intended audience, game play, etc.

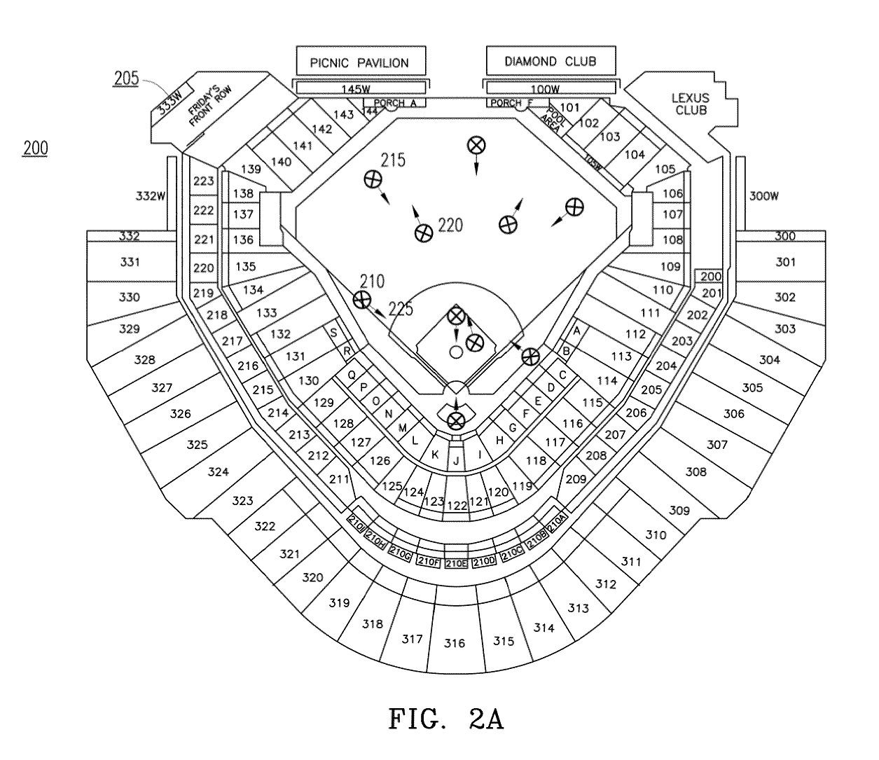

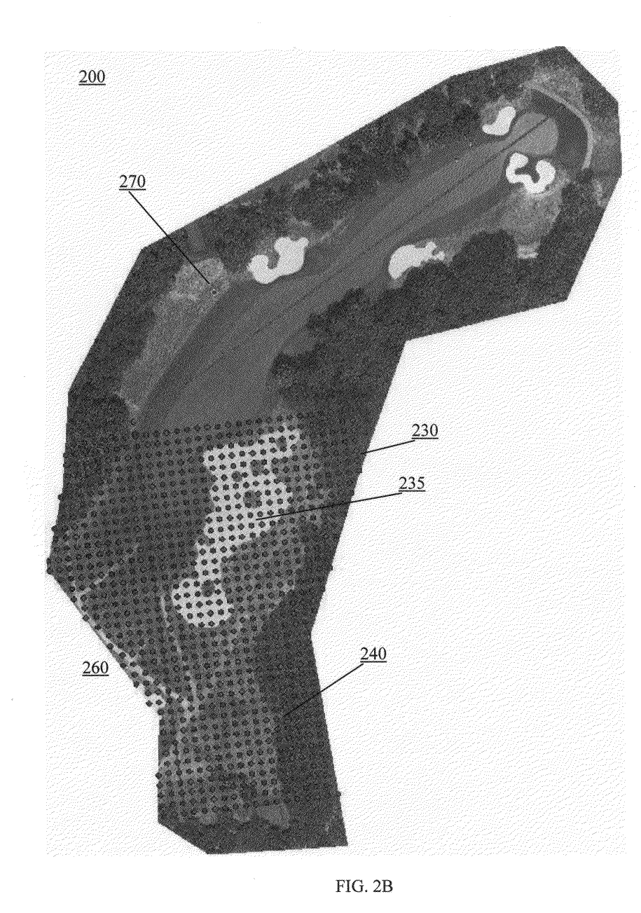

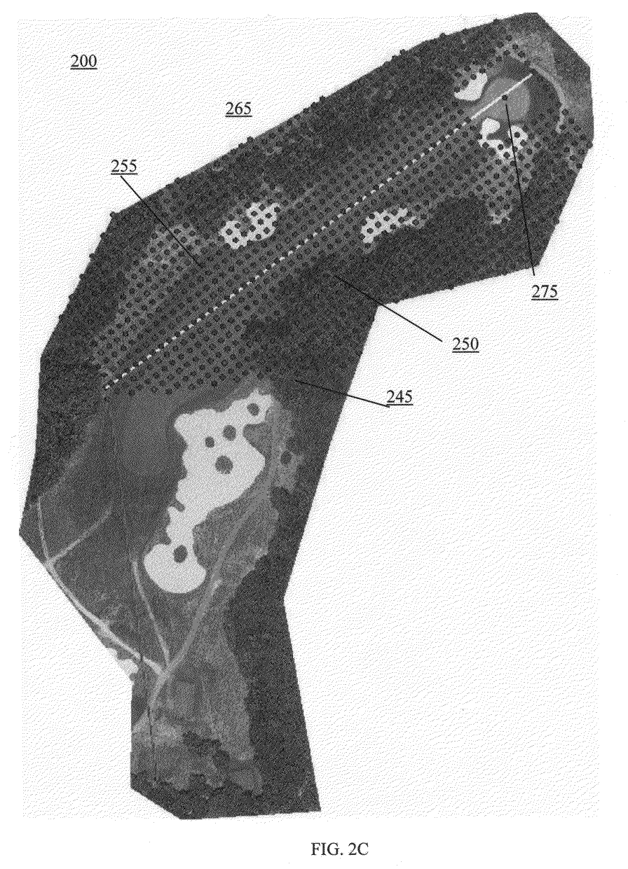

Producing a computer game or other simulation incorporating photographs of a real-world course may require one or more photographers to go on site to the real world course to capture the desired photographs. The term photographer includes automated photography devices, such as robotic photography devices (such as a robotic helicopter armed with a camera), as well as human photographers. FIG. 2A illustrates a map of a real-life course selected by a designer for incorporation into an interactive electronic game. The example illustrated in FIG. 2A might pertain to an electronic baseball simulation game. FIGS. 2B and 2C illustrate sections of a map of a real-world golf course to be used in a golf simulation game. The map 200 can serve to guide one or more photographers in capturing the photographs of the course 205 desired for inclusion in the production of the computer game.

A number of markers (e.g., 210, 215, 220) are illustrated on the map 200 of course 205, representing the locations where photographs should be taken. The map 200 might also include information related to the markers and the taking of pictures from these locations. In some instances, the concentration of needed or desired photographs for use with the computer game interface, may be quite large. For example, FIGS. 2B and 2C illustrate sections of a map of a real-world golf course to be used in a golf simulation game. Each of markers (e.g., 230, 235, 240, 245, 250, 255) represent a location for taking a photograph, and can be arranged in a concentrated grid of markers 260, 265.

Marker instructions can also include instructions relating to the target of the camera. Instructions relating to the target may also be displayed on the map, for example, by a marker arrow (e.g., 225) pointing to the target of the photograph (e.g., 210), as illustrated in FIG. 2A. In other examples, such as the example of FIG. 2B, a target marker 270 is provided, towards which each camera corresponding to a marker or group of markers (e.g. marker grid 260) should be aimed. In FIG. 2B, target marker 270 corresponds to the corner of a dogleg on a golf hole, in FIG. 2C, target marker 275 corresponds to the pin on the green. Additional marker instructions can include the angle of the camera, the focal length of the camera lens, the elevation of the camera, GPS coordinates corresponding to the location of the marker in the real world course, and others. One or more of these instructions may be embodied in a shot list outlining the specific photographs to be taken in accordance with the production and development of a computer game incorporating the photographs.

A photoshoot organized to efficiently and effectively capture the photographic images for incorporation into an interactive computer game can demand detailed planning on the part of the game producers. The photoshoot may require organizing several photographers to work in concert with one another on a real world course. Conditions for shooting the photos can be demanding, for example, the course may need to be closed to accommodate the shoot, allowing for only a limited window in which to successfully and accurately capture the desired images. If robotic cameras, or other programmable photographic apparatus are used in a photoshoot, a detailed plan will need to be in place in order to properly instruct the apparatus to capture all of the photos desired for the computer game.

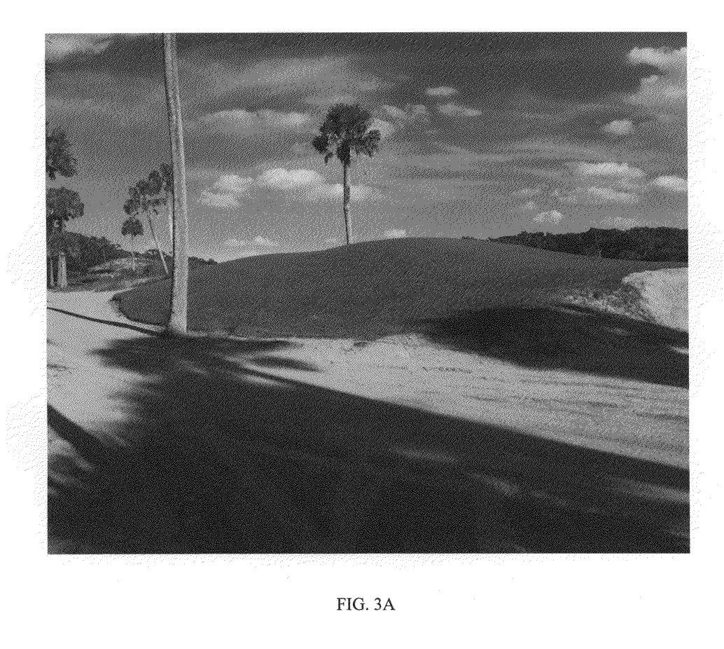

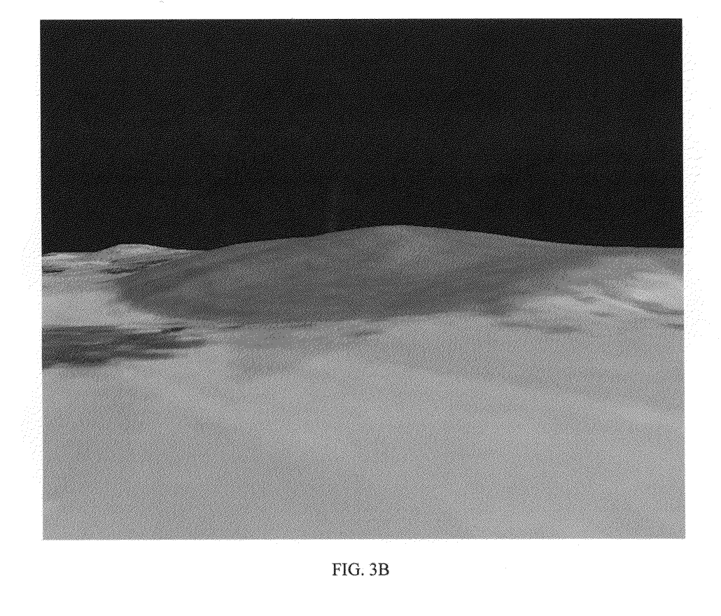

A photoshoot can be pre-visualized by capturing simulated images (or virtual photos) of a virtual environment simulating the appearance and scale of the real world environment sought to be photographed. These views of the virtual environment can be adjusted and re-positioned to simulate views of actual cameras in the real world or physical environment, giving the game designer a preview of the photographs a proposed photoshoot would produce. For example, FIG. 3A illustrates a real photograph of a course to be incorporated in an interactive computer game. FIG. 3B illustrates the field of view of a virtual camera positioned within a 3D virtual environment of the course, the virtual camera aligned to capture a view corresponding to the view of the photograph of the real-world course, illustrated in FIG. 3A. The use of virtual cameras in a virtual environment of the course can serve to allow the game designer to pre-visualize the photographs the designer wishes to capture of a course and integrate into the game. Using this pre-visualization tool, the designer may organize the real-world photoshoot of the course by developing a shot list that may include a photoshoot planning map similar to that illustrated in FIG. 2, for instance.

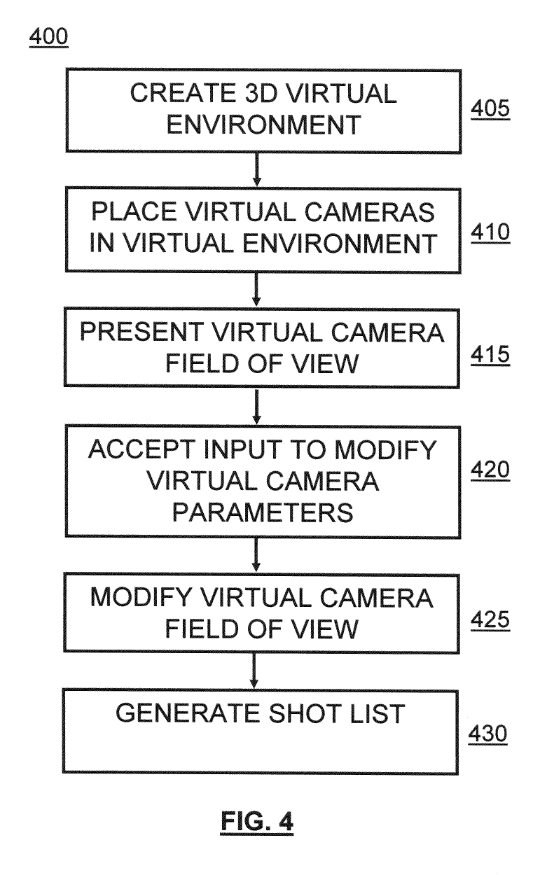

FIG. 4 illustrates a flow-diagram 400 of a computer-implemented technique for pre-visualizing a photoshoot of a real-world course. A 3D virtual environment is created 405 of the real-world course. The virtual environment may be created by texture mapping one or more photographs of the real-world course (for example, an aerial photograph of the course) onto a representation of the course's 3D topography. The 3D topography representation may be a digital elevation map corresponding to the course, for example a terrain mesh. The elevation data in the 3D representation can map to corresponding locations on the course. In some implementations, the elevation map and data is accurate to within a centimeter, however higher and lower resolutions are also possible. Terrain data for use in constructing a 3D topography representation can be collected in a number of ways including, but not limited to, aerial photogrammetric mapping (APM), laser 3D imaging and GPS-real-time kinemetric (GPS-RTK) surveys. The photograph is digitally overlaid on the 3D topography, so as to present image data associated with the course onto the 3D topography. Texture mapping might be performed using bump mapping, normal mapping, parallax mapping, displacement mapping, or any other texture-mapping technique. Implementations may texture map the photograph onto the 3D topography with varying degrees of precision. Aligning the photograph with the corresponding 3D topography can be accomplished, for example, by aligning GPS coordinates of the camera that captured the photograph with the location of a virtual camera having the same or substantially the same view of the 3D topography. For example, some implementations may texture map the photograph so that the section of the course depicted in the 2D photograph is mapped to the same section of the course depicted in the 3D topography. One illustrative example may be a golf course with recessed sand bunkers. The 3D topography corresponding to these bunkers would be lower in elevation than topography corresponding to the grass course surrounding the bunker. The photograph of the same bunker can then be texture-mapped so that the polygons of the depressed section of the 3D topography corresponding to the bunker are shaded with the coinciding sections of the photograph corresponding to the same bunker, giving the 3D topographical representation of the bunker a sandy, more realistic appearance.

More than one photograph may be texture-mapped onto a single 3D topography. Alternatively, portions of a single photograph may be texture-mapped onto more than one 3D height map. This may be desirable when the boundaries of the 3D height map and the corresponding photographic images do not match. For example, the 3D height map may pertain to an entire golf course, whereas the photographs each capture a single hole on the course.

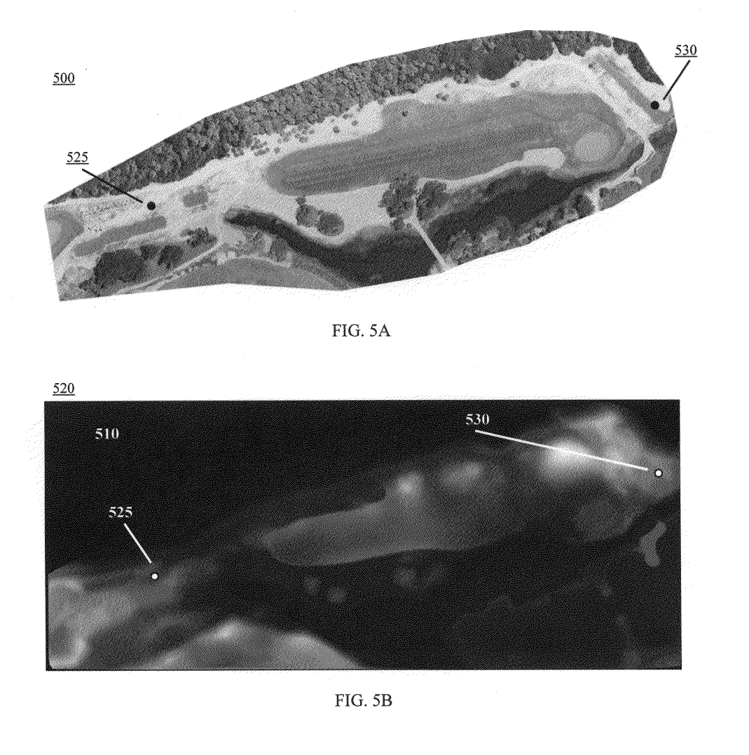

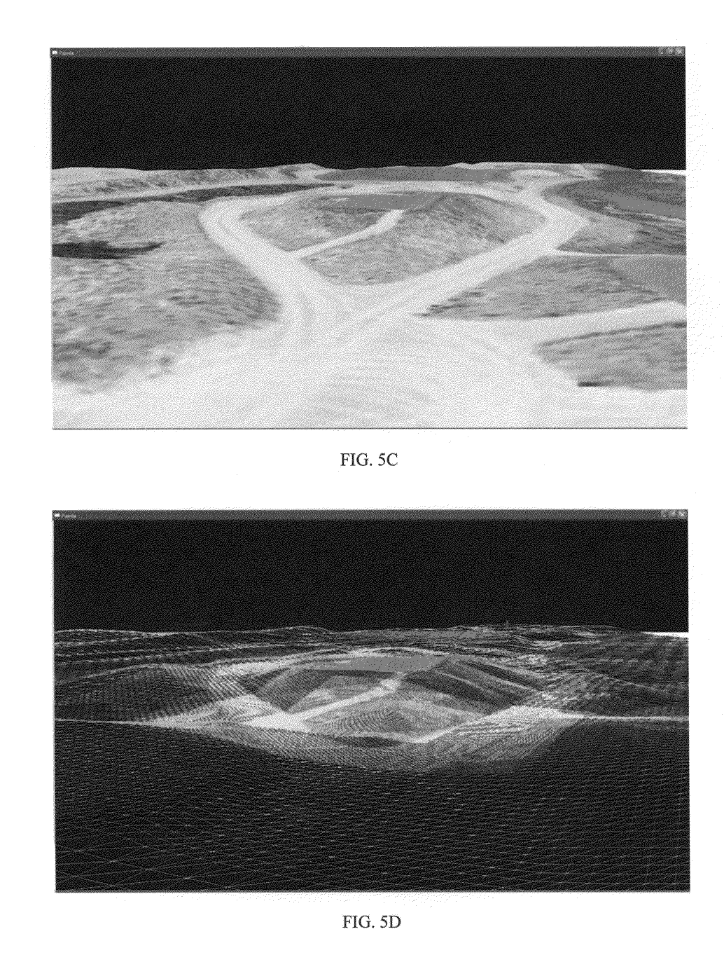

FIGS. 5A-D illustrate a conceptual representation of texture-mapping photographs onto 3D topographies. A real world photograph 500, in FIG. 5A, is provided along with a corresponding 3D topology 510, such as illustrated in FIG. 5B. The real world photograph 500, in some instances, can be a photograph captured by an aerial photographer. The 3D topography can, for example, be a 3D mesh height map, corresponding to at least a portion of the real world photograph 505. In the example illustrated in FIGS. 5A and 5B, a photograph of a golf course 500 corresponds substantially with the area captured by the 3D topology 510 of the same golf course. Upon aligning the respective coordinates of the photograph 500 and the height map 510, the photograph 500 is texture-mapped onto the height map 510, resulting in a 3D texture-mapped representation 520 of the course, as illustrated, for example, in FIGS. 5C and D. FIG. 5C illustrates a view of the 3D representation 520 as captured from a corresponding point 525 on each of aerial photograph 500 and topology map 510, directed toward target reference point 530. FIG. 5D illustrates the same view as in FIG. 5C, the view of FIG. 5D employing a wireframe topology convention to illustrate the topology of the resulting 3D representation 520. As illustrated, and depending on the method of texture-mapping employed, the resulting 3D representation 520 in FIGS. 5C and D appears to include the representative section of the height map 510, near the reference point 525, with the corresponding section of the 2D photograph 500 “draped” over the 3D surface 510. This resulting representation 520 can be employed as a virtual environment in a pre-visualization tool.

Once the virtual environment of a real-world course has been created 405, virtual cameras can then be placed in relation to the virtual environment 410. Each virtual camera can present a field of view 415, the field of view capturing a portion of the virtual environment and displaying it to the user. In this sense, the virtual cameras function like a real camera, as if a photographer were present in the virtual environment and aiming a camera at a portion of the virtual environment. The virtual cameras can be freely positioned within the virtual environment, including various elevations. The virtual cameras can zoom in and out and even apply more unconventional effects, digitally processing the field of view captured by the virtual camera to, for example, distort the image, apply a filter, add a digital lighting effect, or other effects available in digital image editing programs. Additionally, in cases where the virtual camera is to correspond with a stereo pair photograph, two or more virtual cameras can be employed for the photograph and the distance between the virtual cameras set to simulate the stereo pair photograph in the virtual environment.

Users can modify the field of view of a virtual camera. An input can be received 420 from a user to modify one or more parameters of a virtual camera. The field of view of the virtual camera can then be updated 425 and displayed to the user in accordance with the input to modify the parameters of the virtual camera. A user input can modify any available parameter of a virtual camera. For example, the user may reposition the virtual camera in the virtual environment, along one or more of the x-, y-, or z-axes. The user may change the field of view (e.g., zoom in or out), rotate the camera about an axis, change field of view effects, etc. Where several virtual cameras are placed in the virtual environment, inputs can request parameter modifications to one or more of the virtual cameras.

When a user is satisfied with the fields of view captured by the virtual cameras in the virtual environment, the user may then record the parameters of the virtual cameras defining these fields of view. The virtual cameras' parameters may be recorded by generating a shot list 430 for the course. The shot list may be a table, for example, listing the parameter data of each virtual camera applied to capture its respective field of view. Parameter data contained in the shot list can include the position in the real world or physical environment, rotational orientation, elevation, etc. of the virtual cameras. In that the virtual environment corresponds to the actual, real-life course, the parameter data can translate to real-world coordinates and parameters capable of being interpreted by real-life photographers in efforts to duplicate the virtual cameras' fields of view in photographs of the real world course. The shot list may also include a map of the course indicating the positions of the cameras on the course. In some implementations, the shot list may include visual representations of the fields of view of the virtual environment, as captured by the virtual camera, in order to provide the real-world photographer with a reference for the real world photos guided by the shot list. The shot list may also include GPS coordinates or similar data which can be utilized by a robotic or other programmable photographic device to precisely guide the positioning of the camera on the real-world course.

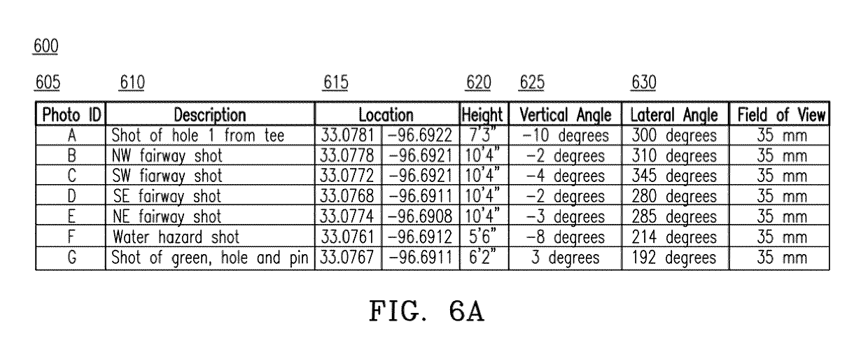

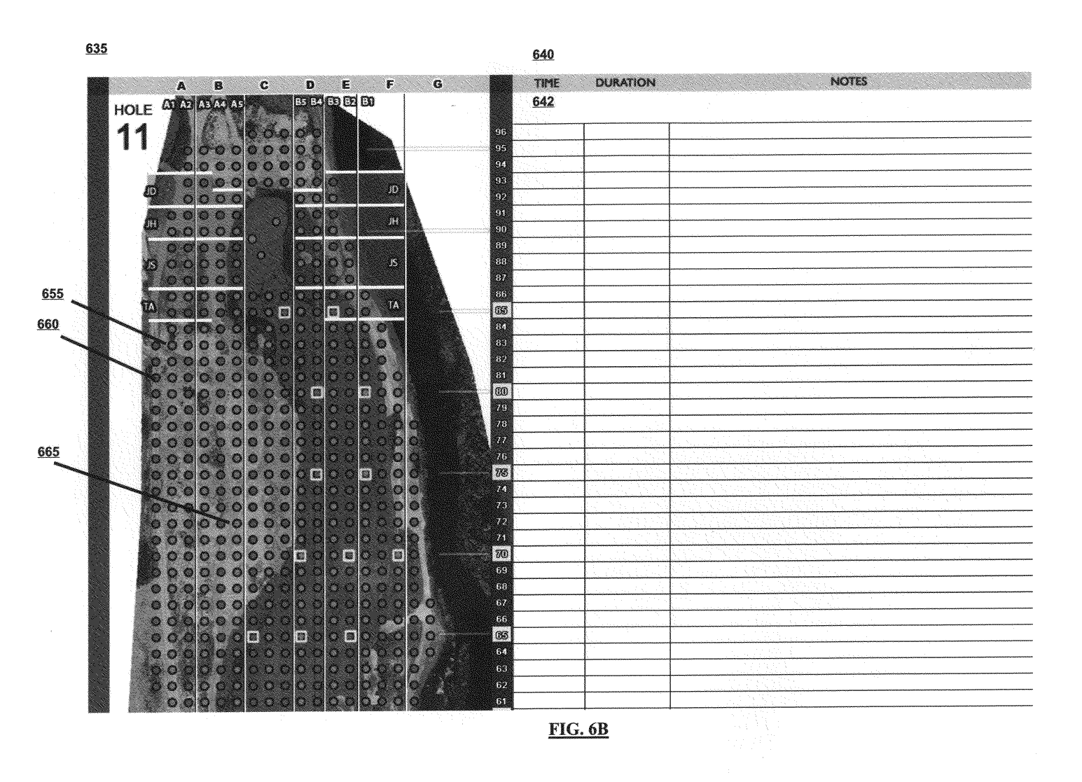

FIG. 6A illustrates an example of a shot list 600 generated using a pre-visualization tool incorporating virtual cameras in a virtual representation of a real-world environment. Fields can be provided listing information that can be used by photographers to capture the actual photographs of the real-world environment sought for inclusion in an interactive computer game. For example, fields may provide a serial number or other identifier 605 associated with a planned photograph, a brief description 610 of the shot or location of the shot, location coordinates 615 corresponding to the latitudinal and longitudinal position the camera should assume, and the height or vertical position 620 of the camera. The shot list 600 could provide additional information for the photographer, including the vertical angle of the shot 625, e.g., the pitch or tilt of the camera from horizontal so as to specify whether the camera is shooting downward, upward, level, etc. Additionally, the shot list 600 can provide information relating to the target of the shot. For instance a lateral angle coordinate 630 can be provided, pointing to the target of the photograph.

FIG. 6B illustrates an example map shot list 635 corresponding to a real-world environment. The map shot list 635 can be provided to replace or supplement data shot lists such as 600, with shot characteristic fields 640 similar to, or supplemental to, the fields of example shot list 600, in FIG. 6A. In some instances, these additional fields 640, can be provided for reporting by photographers as the real world photographs are taken. This can be useful to document, for example, complications that arise during the shoot as well as the conditions of the shot. For example, a time field 642 can be provided, setting forth the time of day the shot was taken, allowing the photographer to record when the shot was taken, so that if a replacement photo is needed, the replacement can be captured under similar conditions. Additional fields can also be provided to allow coordination of a crew of photographers acting in concert to capture images of a course in a short period of time, so that the photographs are captured at roughly the same time of day and under similar light and weather conditions, allowing for visual consistency throughout a set of photographs of a given real world course.

Each of the circular markers (e.g., 655, 660, 665) on the map can serve to illustrate to real-world photographers, where each of the planned photographs is to be taken. Shot list 600 can be consulted in conjunction with the map to provide additional instructions to real-world photographers regarding how cameras should be positioned to capture the desired field of view. The desired field of view can correspond directly with a field of view of the virtual environment as captured by a virtual camera of the pre-visualization tool. For example, in order to capture photograph C, as outlined in row C (645), the camera should be positioned at a height of ten feet, four inches, vertically angled ten degrees below above horizontal, and oriented laterally at 345 degrees relative a given reference. Using these coordinates, the photographer can recreate the virtual camera photograph C in the real world environment.

Additionally, positional references, or even the target of the shot itself, can correspond to a particular landmark of interest to the game designer or simply constitute a reference point for capturing the proper field of view. Reference points, may additionally be marked off with flags or other markers placed in the real-world environment to further aid photographers beyond the coordinates provided for a photograph. These reference points can also be modeled in the virtual environment of the pre-visualization tool. For example, virtual flags can be provided in the virtual environment that can correspond to real flags positioned in the corresponding real-world environment. These markers can also aid processing the photographs, for example, in aligning real-world cameras with virtual cameras, and in stitching together multiple, corresponding photographs. Digital photo-processing software exists allowing game designers to modify the photograph to remove these reference points from the photograph prior to including the photograph in the game itself.

As noted, the desired fields of view outlined by the shot list 600 can correspond directly with fields of view of the virtual environment as captured by one or more virtual cameras of the pre-visualization tool. Indeed, these real-world coordinates presented by a shot list 600 can be provided automatically by the pre-visualization tool. For example, as virtual cameras are positioned within the virtual environment of the pre-visualization tool, the pre-visualization tool can translate the coordinates of the virtual camera's location within the virtual environment into coordinates for the corresponding location in the real-world environment. In addition, to further guide photographers, the pre-visualization tool can assist in building shot lists which can include maps of the real-world environment to be photographed as well as including images of the fields of view captured by the virtual cameras and corresponding to the real-world fields of view outlined in the shot list 600.

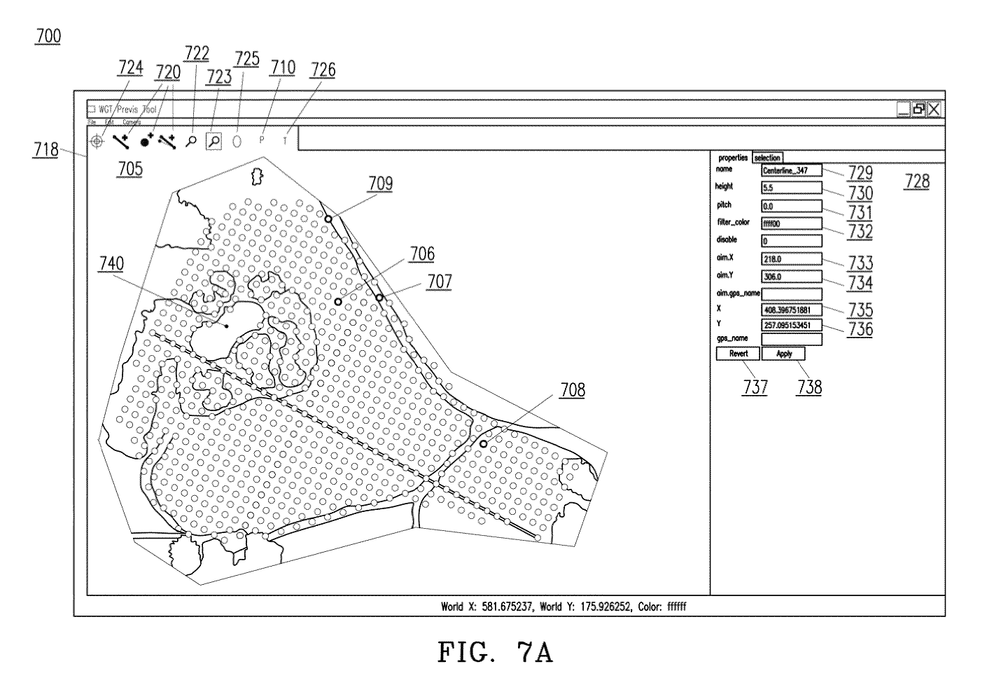

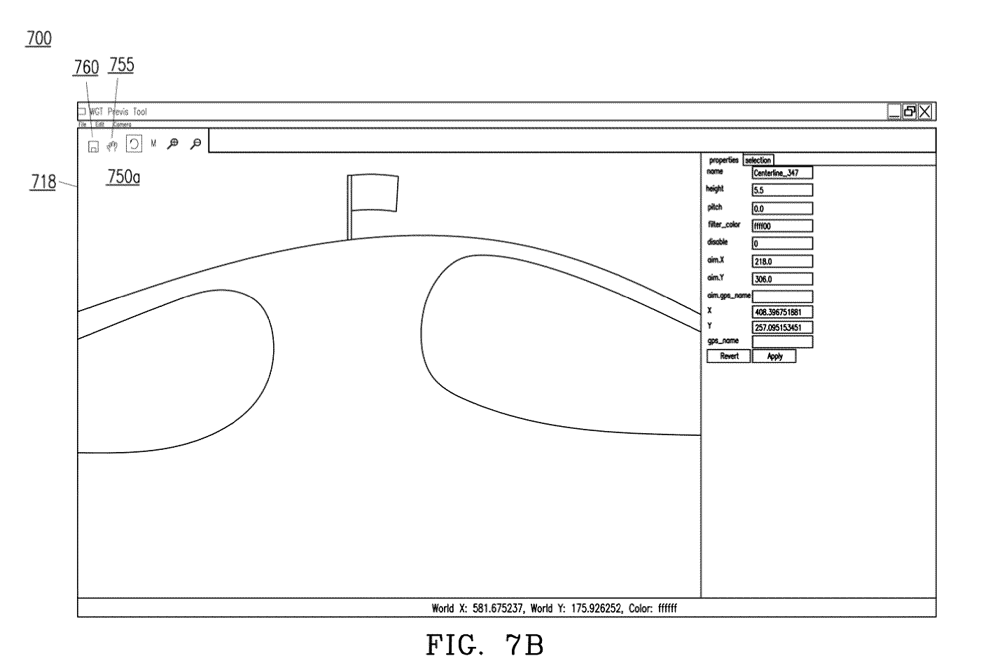

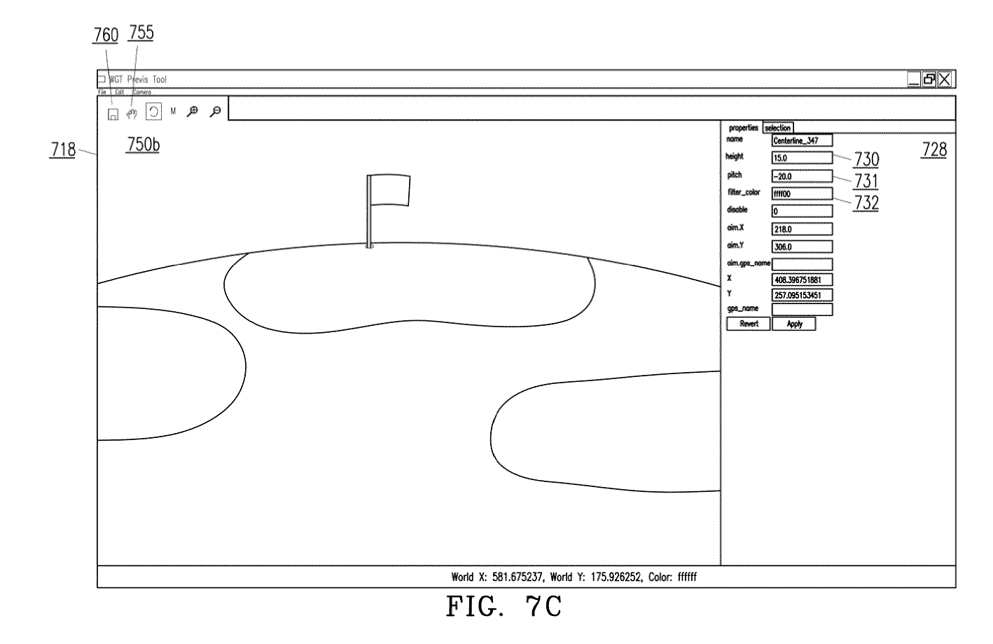

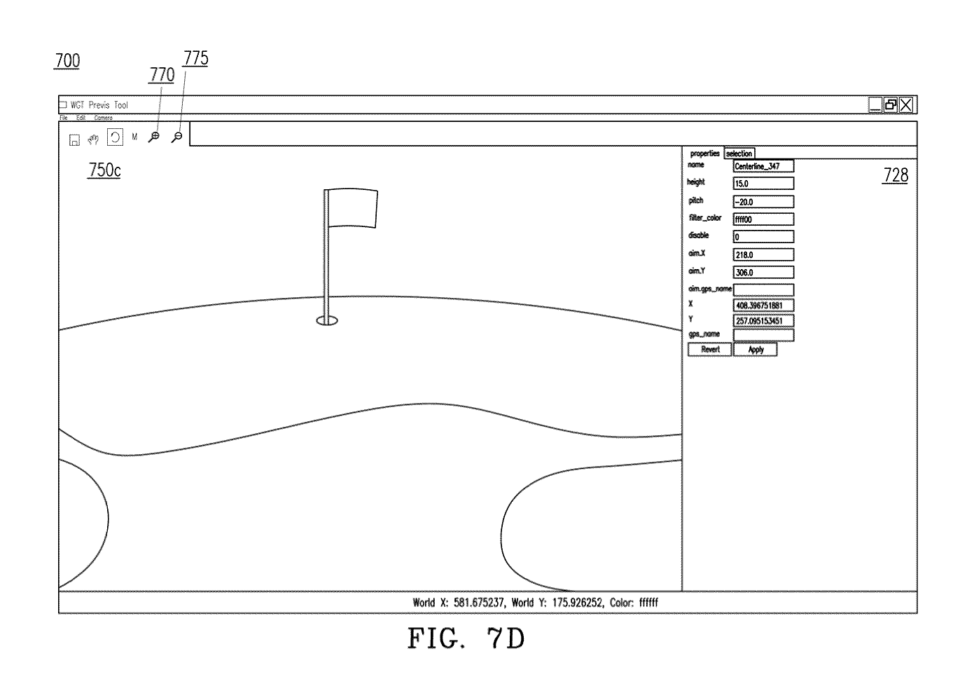

FIGS. 7A-D illustrate screenshots of an example pre-visualization tool employing virtual cameras in a virtual environment. FIG. 7A illustrates one example view of a pre-visualization tool user interface 700. The user interface 700 can present a map 705 of the virtual environment to coordinate placement of virtual cameras (e.g., 706, 707, 708, 709) within the virtual environment. In some implementations, a user of the pre-visualization tool can toggle between a view of the map 705 and a view from a virtual camera placed in the virtual environment in relation to the map 705. In this example, when in the map view 705, a pre-visualized camera view can be displayed by selecting button 710, labeled “P,” positioned on a toolbar 718. Additional buttons can also be provided on the toolbar 718. For instance buttons 720 for placing cameras in the virtual environment can be provided. In this example, three buttons 720 are provided, capable of placing a row of virtual cameras, a single virtual camera, or a grid of virtual cameras in the virtual environment. Additionally, buttons 722, 723 can be provided for zooming in on the map 705 to make placement of the cameras more convenient for the user. Additional buttons 724, 725, 726 can also be included allowing users to, for example, view an enhanced topology of the map 705, place guides, or select an individual camera. An additional pane 728 can be provided allowing users to directly define various parameters and characteristics of each camera or group of cameras, as well as camera targets and other features. For example, the name 729, camera height 730, camera pitch 731, lens filter color 732, camera target location coordinates 733, 734, and camera location coordinates 735, 736 can be edited for each selected virtual camera, through the fields 729-736 in editing pane 728. Additional buttons 737, 738 can also be provided, allowing users to undo and apply changes made in fields 729-736 for the selected virtual camera.

Icons 706-709 can be placed on the map 705 to represent the position of virtual cameras and virtual camera targets within the virtual environment. For example, a camera icon 706 can represent the position of a virtual camera within the virtual environment. Users of the pre-visualization tool, in some implementations, can drag, drop, and reposition the camera icon 706 to correspond with a desired location for a virtual camera. In some implementations, the orientation of a positioned virtual camera can be specified by the user through the positioning of a target icon 740. The target icon 740 can represent the target of the virtual camera positioned at 706, the target icon 740 effectively defining a direction of focus for the virtual camera 706.

FIG. 7B illustrates the user interface 700 of the pre-visualization tool in a camera view mode. The virtual camera view 750a displayed to the user, in this example, corresponds with the view defined by icons 706, 740 in FIG. 7A. In camera view mode, additional or substitute buttons and tools can be provided on the toolbar 718, allowing a user to adjust the positioning and orientation of the selected virtual camera while surveying the effect of the adjustment on the virtual camera's view. A Hand tool 755 can be provided, allowing the user to drag the view laterally to the left or right, effectively moving the position of the virtual camera orthogonal to the original camera direction. The Hand tool 755 can also operate to move the camera view vertically up and down, effectively changing the elevation of the camera in the virtual environment. Adjusting the virtual camera view 750a presented to the user also serves to adjust the position and orientation coordinates stored by the pre-visualization tool corresponding to real-world coordinates. These coordinates can be used for positioning a real camera in the corresponding real-world environment to capture a photograph corresponding to the simulated image 750a. When a user is satisfied with a virtual camera's view, and thereby its position within the environment, the user may save the position and orientation characteristics, as well as the virtual camera image 750a itself, by selecting a Save button 760.

FIG. 7C illustrates the operation of an additional virtual camera positioning tool capable of being implemented in some versions of the pre-visualization tool. For instance, a Rotate tool 765 can be provided to adjust the vertical or lateral angle of the virtual camera. The illustrated view 750b could be generated from the view 750a of FIG. 7B by, for example, first adjusting the elevation of the virtual camera using, for example, the Hand tool 755, and then adjusting the vertical angle of the virtual camera lens downward using the Rotate tool 765. Adjustments to the virtual camera characteristics can be reflected in panel 728, for example by pressing Save button 760, as is shown in the camera height 730 and pitch fields 731. In some instances, changes made to the fields in pane 728 can be automatically reflected in field of view 750. For instance, if the filter color is adjusted in field 732, the field of view 750 displayed in the user interface can be modified to show how the new filter color would modify the virtual photograph, and thereby a photograph taken using a real-world filter of the same color.

FIG. 7D illustrates the operation of Zoom-In and -Out buttons 770, 775 also presented in the toolbar 718. The Zoom-In and -Out buttons 770, 775 can operate to adjust the virtual camera's zoom setting and/or adjust the camera's position backward or forward toward the target, effectively zooming in or out on the target. In FIG. 7D, Zoom-In button 770 has been used to zoom-in the virtual camera's field of view, adjusting FIG. 7C's field of view 750b to result in view 750c. Additional tools and functionality can also be provided. While FIGS. 7A-D illustrate one example of a pre-visualization tool user interface, it will be appreciated that any suitable user interface layout can be adopted, as well as substitute functionality for positioning and orienting virtual cameras within a virtual environment.

Some implementations of the pre-visualization tool may be capable of guiding the user of the tool in deciding how and where to place virtual cameras within the virtual environment. As discussed above, virtual reference points may be set in the virtual environment. The pre-visualization tool may guide a user by, for example, training virtual camera views automatically toward virtual reference points. In other implementations, the virtual tool may determine a suggested density of virtual cameras within portions of the virtual environment.

One example, illustrated in FIG. 8, allows the tool user to select certain regions of the virtual environment that are amenable to more detailed presentment to the game player. Using these selected regions, the pre-visualization tool may suggest the placement of virtual cameras, automatically suggesting a higher density of virtual cameras capturing fields of view incorporating the selected regions. For example, the pre-visualization tool may automatically divide a virtual environment into grid-like sections and place virtual cameras at each grid point (e.g., 805, 810, 815), as illustrated in FIG. 8. The pre-visualization tool can be used to identify those sections of the virtual environment where more photographs will be desired. For example, in FIG. 8, a golf course terrain 800 is illustrated. The portions of the virtual environment representing features of the golf course where more detail may be useful for the game player can be provided with a higher density grid and thereby a higher density of photographs. For example, a section 820 of the course 800 corresponding to bunkers 822, 825 and the green 830 have been identified, using the pre-visualization tool, as requiring more photographs to build the proper representation of the scene in the computer game. Accordingly, the pre-visualization tool has assigned a higher density of grid-squares to section 820. The pre-visualization tool may identify these areas automatically, for, by example, detecting color, texture, height map gradients, or other areas of interest. Additionally, some implementations may allow the user to manually designate which sections of the course should have a higher density of suggested views generated by the pre-visualization tool. Additionally, the pre-visualization tool can allow the user of the pre-visualization tool to edit the position and density of camera position suggestions after the pre-visualization tool generates the suggested positions. Further, the orientation of the grids can also be adjusted as appropriate. For example, grid sections 835 and 840 of FIG. 8 are oriented scant to one another, corresponding to different sections of a dogleg of the golf course hole 800. Orienting the grid may be appropriate, for example, where virtual cameras in a section have a substantially common target (for example the corner of a dogleg or the pin in a golf game, such as in FIG. 8), the orientation of the grid corresponding generally to the location of the common target.

The pre-visualization tool can further assist game designers in building a set of photographs for inclusion in an interactive computer game by providing additional functions for simulating how real world photographs might fit within the computer game design. For example, as illustrated in FIG. 9, the pre-visualization tool might allow game designers to place extraneous graphic objects within the virtual environment. Graphic objects can be 2D or 3D graphics, and can model elements of the real world environment, such as trees on golf course. Additionally, interactive computer games may incorporate the presentment and manipulation of an avatar, vehicle, or other object that can interact with the virtual environment, interact with other virtual objects, and be interactively controlled by a player of the game. For example, FIG. 9 illustrates a golfer avatar 905 overlaid on the field of view 910 of a virtual camera in a virtual environment of a real golf course. An additional scoreboard object 915 is overlaid on the field of view 910. The image illustrated in FIG. 9 may be presented as part of an effort to design a golf simulation game incorporating real-world photographs. In this example, both the golfer avatar 905 and scoreboard 915 objects are computer-generated graphics.

Superimposing extraneous objects, such as 905, 915, on the field of view 910 of the virtual camera, can allow designers to appreciate the scale and context of the particular field of view relative to other graphics and objects that will be part of the interactive computer game. Integrating objects that model these additional graphics and objects allows the game designer to model and visualize how a user interface of the game will incorporate some or all of the objects together with a particular field of view displayed by a virtual camera. By so doing the game designer can determine whether the particular characteristics of the virtual camera's field of view are appropriate for the game's design. This can, in turn, allow game designers to determine what photographs should be taken of the real world course and how these photographs are to be taken before sending photographers out to the real-world course.

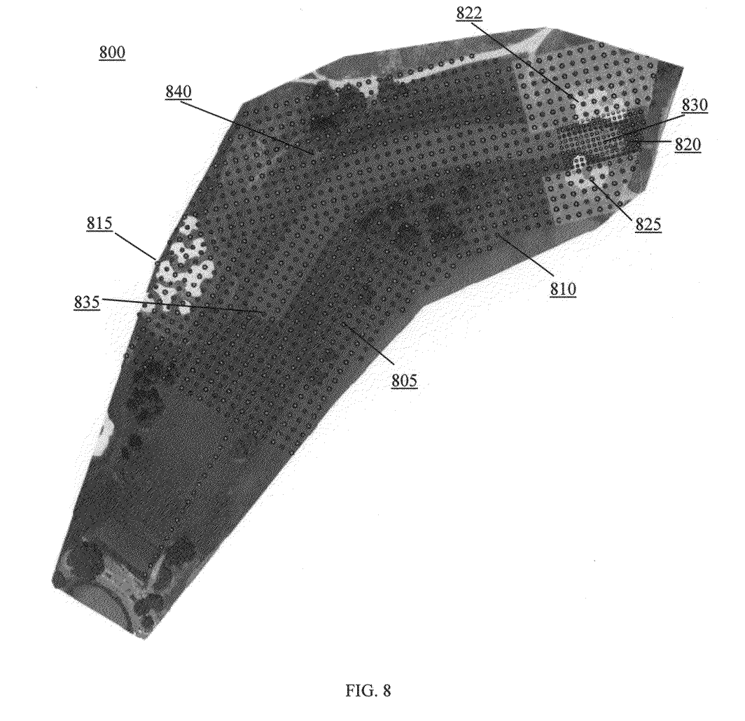

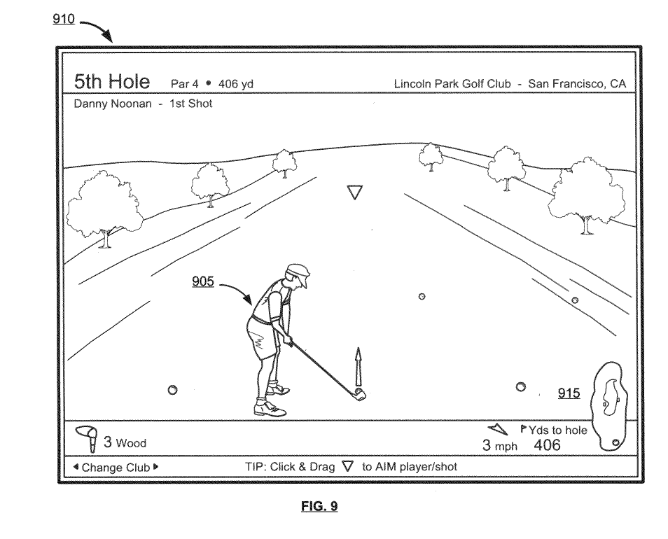

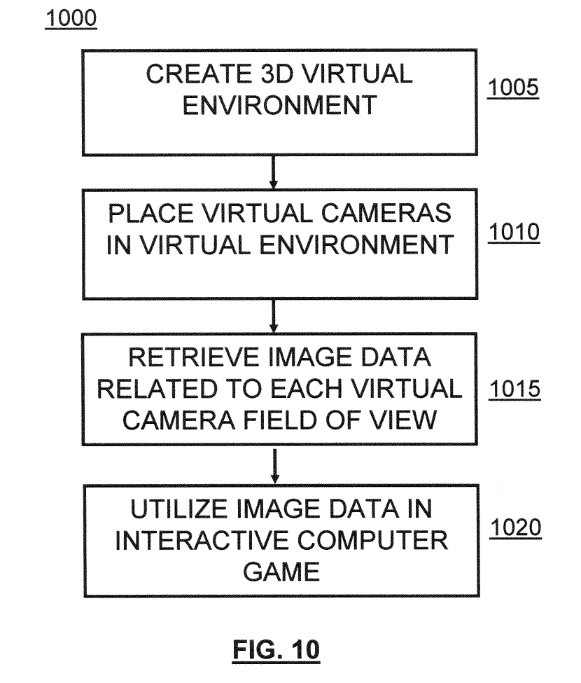

In addition to allowing the game designer to position graphical objects within the virtual environment or to superimpose modeled objects onto the fields of view, it may be desirable to simulate the computer game, including its functionality, using the fields of view of the virtual cameras. Allowing game designers to simulate the computer game before capturing the actual photos, further allows designers to mitigate against photos being taken that are later determined to be unsuitable for inclusion in the computer game. FIG. 10 is a flow-diagram of a technique for incorporating images of a virtual environment into a simulation of an interactive computer game. At 1005, a 3D virtual environment is created. The 3D virtual environment may be created in accordance with the steps described in conjunction with FIG. 4, for example. Virtual cameras are then placed in relation to the virtual environment 1010, so that each virtual camera captures a view of the virtual environment. The field of view of each virtual camera may capture a panoramic view of the landscape of the virtual environment, or only capture a portion of the virtual environment. The fields of view of the virtual cameras can be adjusted, for example, by changing the position of the virtual camera, adjusting the tilt, zoom, angle of the view, or any other characteristic of the virtual camera. These modifications to the virtual camera can then be reflected in the field of view itself. A plurality of virtual cameras can be placed in the virtual environment simultaneously so as to capture a set of virtual fields of view. Virtual cameras can also be paired so as to capture sets of 3D-type stereo images for use in 3D computer games, for example.

Having positioned virtual cameras within the virtual environment, image data corresponding to the resultant fields of view can then be retrieved 1015. These fields of view can be retrieved as image files or other data capable of being used by an interactive computer game to present the fields of view as part of the graphical user interface of the computer game. For example, the data may define an image captured by the virtual camera or only a portion thereof. Image data may be combined with other image data to build images for use in a computer game. For example, two adjacent images may be “stitched” together to form a contiguous image encapsulating a larger view of the virtual environment, for example a 360 degree panoramic view of the virtual environment. Other image data can be incorporated with the image data from the virtual cameras. For instance, a graphic, such as an avatar or a virtual object, such as described in conjunction with FIG. 9, may be associated with the image data so that the graphic is displayed with the view of the virtual camera.

Upon capturing the virtual camera image data, the image data can be utilized in an interactive computer game 1020. For example, the image data can be utilized to generate the user interface of the computer game. In some implementations, the computer game may employ a game testing engine, designed to utilize the virtual camera image data to simulate the functions of the computer game. The game can utilize the image data by simulating the flow and user interaction of the game. Loading the image data into the game can allow a designer to play the game, with the virtual camera images acting as placeholders for the real-world photographic images the designers plan to integrate into the production version of the game.

The image data utilized by the game can define a set of images. As the game is simulated using the image data, individual images can be selected from the set and displayed to the user. The selection and display of the images can be dependent on the state of the game as well as the user's interaction with the game. As an example, in a golf simulation game, the user may provide a command that a golf player-avatar strike a golf ball. This first swing may represent a first state. In response to the user command, a virtual object representing the ball may be launched into a trajectory corresponding to the user's inputs, simulating the flight of a golf ball. This virtual object may interact with the playing field represented by the displayed image data, the image corresponding to the field of view of a virtual camera. Interactions may model a virtual object's or avatar's interaction with the physical characteristics of the course, for example a ball bouncing along the undulations of a golf course. In that the virtual images utilized by the game during a simulation are views captured of a virtual environment modeling a real-world environment, these interactions with the virtual images utilized by the game may model physical characteristics of the corresponding real world environment. For example, intelligence may be provided in the game to simulate the collision of the object against various course surfaces. Collision modeling may be employed, for example in a golf game, to produce a different reaction when the ball comes into contact with a portion of the course modeling a cart path, than when the ball contacts a sand trap. Additionally, the game may provide for masking, in that an object may disappear and reappear from behind other objects or even elements of a photograph, such as a tree, to simulate the objects' interaction with the photograph.

Continuing with the example of a golf game, when a golf ball object comes to rest after an initial swing, the game may require that the user take another swing at the ball from the landing position of the virtual golf ball on the course. This second shot from a different location on the course may be considered a second state of the game. In order to facilitate this second shot, the game code can select an image from the retrieved set of virtual camera images corresponding to a view of the course taken from this landing position, thereby selecting the image based on this second game state. Allowing the game to dynamically simulate how photographic images may be integrated into the game play, allows designers to pre-visualize not only the appearance of the game's eventual interface with the real-world photographs, but also the interactive game play involving the photographs. This game simulation may also provide designers with the ability to make notes, flag particular virtual camera image data, or record other adjustments or feedback data as they simulate the game using the virtual camera image data and observe how the virtual camera images meet, exceed, or fall-short of the designer's expectations. In some implementation, the simulation may collect feedback data automatically, for example, by monitoring virtual objects' interaction with an image retrieved from a virtual camera.

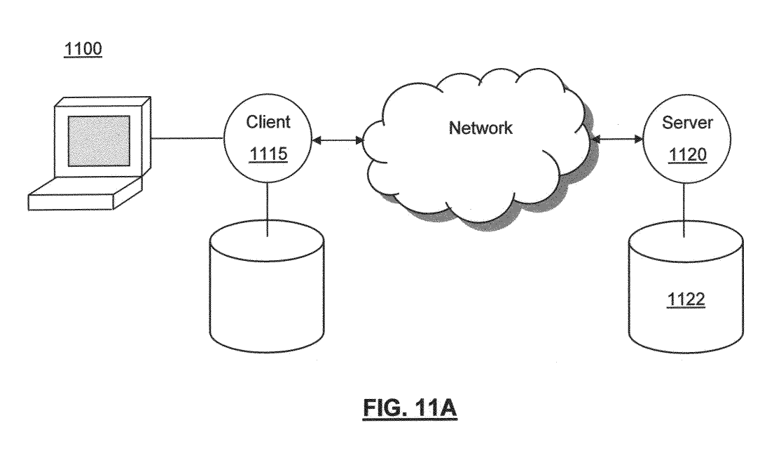

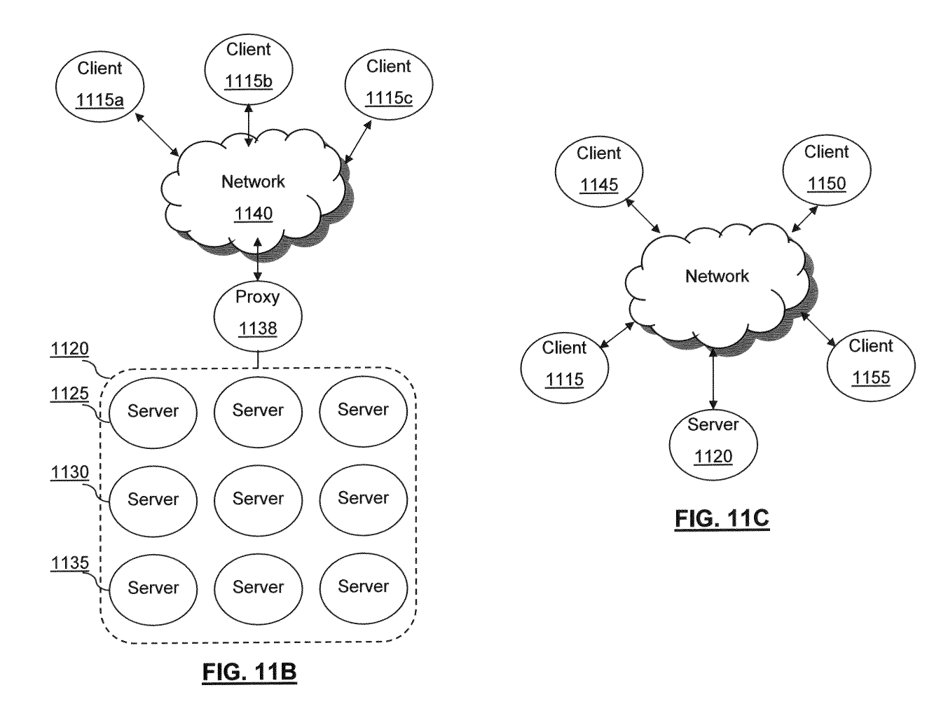

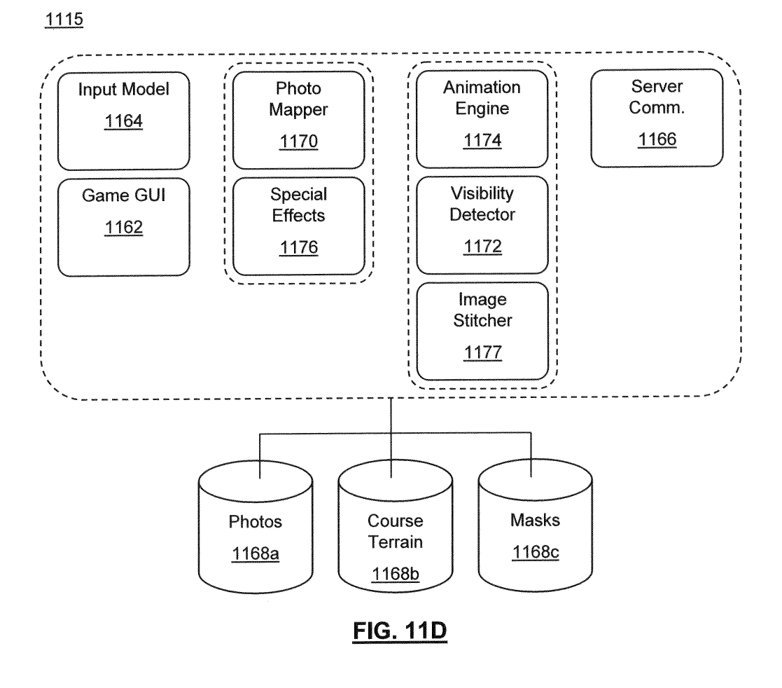

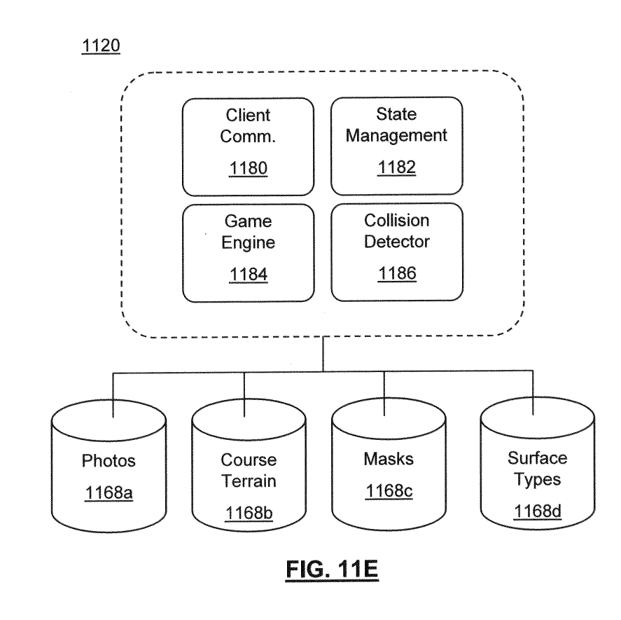

FIG. 11A is a schematic diagram of an example interactive computer game system 1100. Generally, the system 1100 includes a computing device including a graphical user interface (GUI) 1115 for obtaining user input, presenting photographs that incorporate visual representations of virtual objects, and enabling user interaction with the photographs. The user interface functions in cooperation with a game server module 1120. The game server module includes functionality for modeling the movement of virtual objects in a virtual course through simulation or other means, the functionality responsive to inputs received at the user interface 1115. The game server module 1120 includes local or remote storage 1122 for game assets such as course photographs, course terrain data, game parameters, game state, and other information. In some implementations the game server module 1120 is housed locally together with the user interface 1115, for example, on personal computer, laptop, or game console. In other implementations the user interface 1115 and game server module 1120 function together in a client-server relationship. For example, subsets of the information stored, processed, or managed by the game server module 1120 may be provided to a user interface client 1115 as needed. In some implementations, the game server module 1120 may be partitioned between a client computing device local to the user interface 1115 and one or more remote servers. Indeed, as illustrated in FIG. 11B, the game server module 1120 can include several computing devices or servers (e.g., 1125, 1130, 1135), the user interface computer 1115 communicating with the game server module 1120 through a proxy server device 1138 over a network 1140. Further, as illustrated in FIG. 11C, a plurality of client user interfaces (e.g., 1115, 1145, 1150, 1155) can share a common game server module 1120.

FIG. 11D is a schematic diagram of an example client computing device 1115 including a graphical user interface. The client 1115 includes functionality expressed as software components which may be combined or divided to accommodate different implementations. A game GUI 1162 can present photographs in which virtual objects are mapped, prompt users for input, and provide users with visual, audio and haptic feedback based on their input, for instance. In various implementations, the GUI is implemented as an Adobe Flash presentation (the Adobe Flash Player is available from Adobe Systems Incorporated of San Jose, Calif.) however other implementations are possible. An input model component 1164 interprets user input from one or more input devices as signals. For example, computer mouse input could be interpreted as a golf club backswing signal, a forward swing signal, or a directional signal for pointing a golf club head towards a target such as a golf hole in an interactive golf simulation game. Signals from the input model 1164 are provided to GUI 1162 which can, in turn, provide feedback visual, audio, haptic feedback, or combinations of these. For example, as a user provides input to swing a virtual golf club, the virtual club is shown swinging, and the user hears the sound of a golf club swing.

Additionally, the signals can be provided to a server communication component 1166 which is responsible for communicating with a game server module 1120. The communication component 1166 can accumulate signals over time until a certain state is reached and then, based on the state, send a request to the game server module 1120. For example, once input signals for a complete swing have been recognized by the server communication component 1166, a request to the game server module 1120 is generated with information regarding the physical parameters of the swing (e.g., force, direction, club head orientation). In turn, the game server module 1120 sends a response to the client 1115 that can include a virtual object's path through the virtual course based on the physical parameters of the swing, 2D photographs required to visually present the path by the GUI 1162, course terrain information, course masks, game assets such as sounds and haptic feedback information, and other information. In addition, some information can be requested by the client 1115 ahead of time. For example, the client 1115 can pre-fetch photographs, course terrain information, and masks for upcoming scenes from the game server 1120 and store them in a photograph cache 1168a, terrain cache 1168b, and mask cache 1168c, respectively.

As noted above, the game server functionality can be partitioned between remote game servers and the user interface device 1115 itself so that the client device 1115 is provided with information or functionalities to be utilized in cooperation with the functionality of the game server 1120. For example, the client 1115 may be provided with a photo mapper component 1170 that maps virtual objects in the 3D virtual course to corresponding 2D photographs stored in conjunction with locations on the 3D virtual course. The photo mapper component 1170 can utilize a visibility detector component 1172 to determine whether a virtual object being mapped to a photograph would be hidden or masked by elements of the course terrain represented in the photograph.

An animation engine component 1174 can be further provided, responsible for animating movement of virtual objects in photographs, such as animating the movement of an avatar or other object presented in conjunction with the photographs. The animation engine 1174 can determine animated movements simulating the virtual objects' interaction with course terrain features illustrated in the photograph. For example, the animation engine can animate a golf ball virtual object as it flies in the air, collides with other virtual objects or the virtual terrain, and rolls on the ground. The animation engine 1174 determines a series of locations for the golf ball in a photograph based on the ball's path through the virtual course. In various implementations, the locations in the photograph can be determined by interpolating between the path positions and mapping the positions to the photograph's coordinate system (e.g., by utilizing the photo mapper 1170).

A special effects component 1176 can be used to enhance photographs by performing image processing to alter the lighting in photographs to give the appearance of a particular time of day, such as morning, noon or evening. Other effects are possible including adding motion blur for virtual objects animated in photographs to enhance the illusion of movement, shadows, and panning and tilting the displayed view of the virtual terrain for effect based on the game play. Additionally, it may sometimes be advantageous to combine two or more photographs into a single continuous photograph, such as when the “best” photograph for a virtual object would be a combined photograph, to provide a larger field of view than what is afforded by a single photograph, or to create the illusion that users can freely move through a course. In some implementations, an image stitcher component 1177 can combine two or more photographs into a continuous image by aligning the photographs based on identification of common features, stabilizing the photographs so that they only differ in their horizontal component, and finally stitching the images together. The image stitcher 1177 can be utilized by the photo mapper 1170 to combine photographs.

FIG. 11E is a schematic diagram of an example server 1120. The server includes a client communication component 1180 which is responsible for accepting requests from clients 1115 and providing responses that satisfy those requests. By way of illustration, a request from a client 1115 for the path of a virtual object in a virtual course can include parameters that characterize the user's swing of a virtual golf club. The corresponding response to this request would be the path of the virtual golf ball in the virtual course and, optionally, a set of photographs 1168a, terrain information 1168b, and course bitmap masks 1168c for areas of the physical course that capture the path of the virtual golf ball. Alternatively, some or all of the information relevant to the path can be obtained in separate requests by the client 1115 which allows the client to pre-fetch information to improve responsiveness. A given request or response results in the transmission of one or more messages between a client 1115 and the server 1120.

A state management component 1182 maintains the current state of the virtual universe for each user interacting with the server 1120 through a client 1115. A state includes user input and a set of values representing the condition of a virtual universe before the user input was processed by the game engine 1184. The set of values include, for example, identification of virtual objects in the virtual universe, the current location, speed, acceleration, direction, and other properties of each virtual object in the virtual universe, information pertaining to the user such as current skill level, history of play, and other suitable information. The state is provided to the game engine 1184 as a result of receiving a request from a client 1115, for example.

The game engine 1184 determines a new virtual universe condition by performing a simulation based on user input and a starting virtual universe condition. In various implementations, the game engine 1184 models the physics of virtual objects interacting with other virtual objects and with a course terrain in the interactive computer game and updates the user's virtual universe condition to reflect any changes. For example, the game engine 1184 may utilize a collision detector 1186 and surface types 1168d for modeling the collision and interaction of virtual objects with other objects and the terrain itself. In addition to these functionalities, some or all of the functionality components 1170, 1172, 1174, 1176 illustrated in conjunction with the client 1115 in FIG. 11D, can instead or redundantly be provided in conjunction with the remote game server 1120.

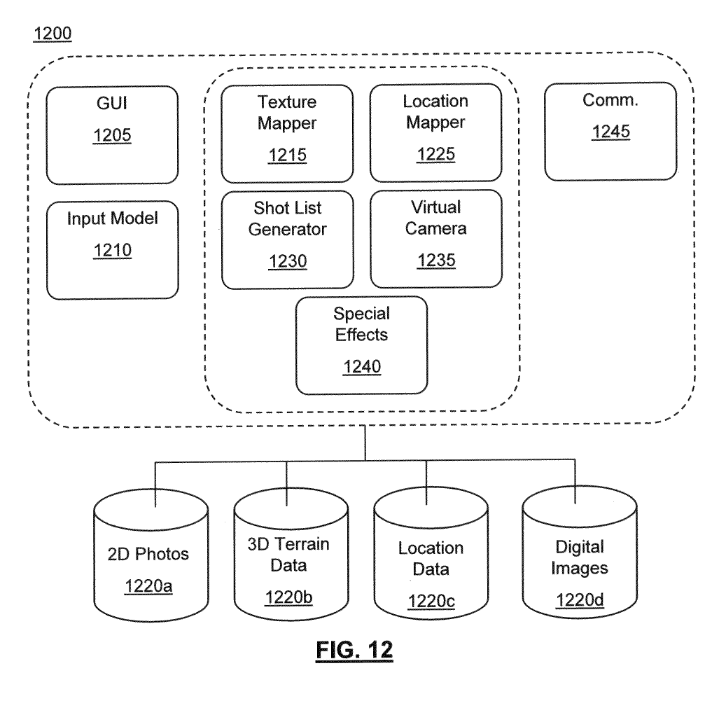

FIG. 12 is a schematic diagram of an example pre-visualization system 1200. The pre-visualization system 1200 includes functionality expressed as software components which may be combined or divided to accommodate different implementations. A GUI component 1205 can present to the user of the pre-visualization system the views of virtual cameras positioned within a virtual environment, including tools for positioning the virtual cameras, and positioning the virtual cameras within the virtual environment. An input model component 1210 interprets user input from one or more input devices as signals. For example, inputs could be received through a computer mouse, keyboard, or other input device, the input model component interpreting the user inputs to direct the pre-visualization system to perform certain functionalities, such as controlling a virtual camera and building a shot list based on virtual camera views of a virtual environment.

The pre-visualization system 1200 can be provided with additional information or functionalities including an environment builder component 1215. The environment builder can texture-map photographic images 1220a onto 3D terrain data 1220b to build a 3D virtual environment modeling a real-world terrain. A location mapping component 1225 can incorporate and associate geospatial data 1220c with the virtual environment built using the environment builder 1215. For example, the location mapping component can associate GPS data of the real world terrain with the virtual environment modeling the real world terrain. The location mapper 1225 can serve to provide position data of individual virtual camera views used to build a shot list for photoshoot for an interactive computer game. A shot list builder component 1230 can compile this position data with other data returned by the pre-visualization system's functional components to create these shots lists.

A virtual camera component 1235 can manage the functionality of positioning virtual cameras within the virtual environment, the virtual cameras capable of capturing views of the virtual environment corresponding to the cameras' positions within the virtual environment. These views may be presented to the user through the GUI 1205. The virtual camera component 1235 can respond to user commands delivered through the input component 1210 to modify and control the position, orientation, and other characteristics of the virtual environment so as to customize the fields of view captured by the virtual cameras and displayed to the user. With the user able to position the virtual cameras as desired, the pre-visualization system can also extrapolate data corresponding to the fields of view captured by the virtual cameras so as to generate a shot list. The shot list generator 1230 can collect data corresponding to the virtual cameras and their fields of view and translate this data into real world measurements and instructions for use by photographers charged with taking photographs of the real world terrain corresponding to the virtual cameras' fields of view. For example, GPS data may be retrieved by the location mapper 1225 representing the location of a virtual camera were it placed in the real world terrain.

A digital effects component 1240 can also be provided to simulate the layout of virtual objects, avatars, and other digital image enhancements planned for inclusion in a production version of the computer game. For example, a digital image 1220d, not otherwise included in the virtual environment, can be positioned by the digital effect component 1240 within the virtual environment so that the digital image is displayed to the user. FIG. 9 is an illustrative example of digital images of a golfer avatar holding a club, a golf ball positioned on the surface of the virtual environment terrain.

Some implementations of the pre-visualization system 1200 may assume a client-server architecture, with one or more functional components (e.g., 1225, 1230, 1235, 1240) and memory stores (1220a, 1220b, 1220c, 1220d) partitioned between a client computing device and a remote server. In order to facilitate communication between the client and server devices, a communication component 1245 can also be provided.

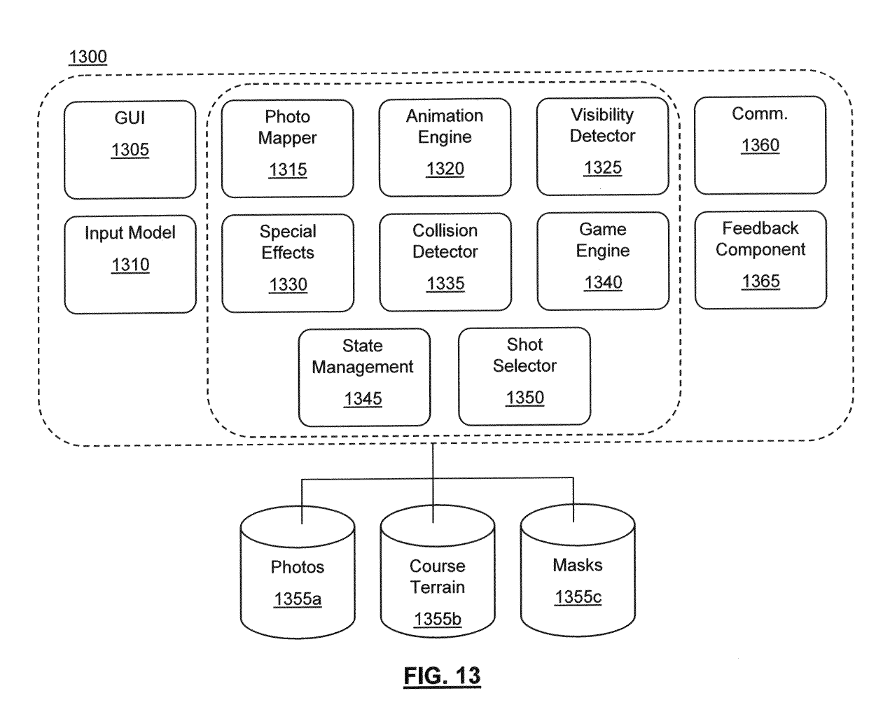

FIG. 13 is a schematic diagram of an example game simulation system 1300. The game simulation system 1300 includes functionality expressed as software components which may be combined or divided to accommodate different implementations. A GUI component 1305 can present the simulated game interface to the user, the game incorporating the virtual environment and virtual photos collected from view of virtual cameras positioned within the virtual environment. An input model component 1310 interprets user input from one or more input devices as signals. For example, inputs could be received through a computer mouse, keyboard, game joystick, or other input device to provide game play inputs into the game simulator, allowing the user to effectively play a version of the game incorporating the virtual environment and virtual photos. Additionally, the input component 1310 can receive user inputs relating to user feedback of the simulation experience.

In that the game simulation system 1300 is intended to simulate an interactive computer game system as it would be played and experienced on a full version of the game, the game simulation system 1300 can share many of the functional components of a full game system, for example, the interactive game system 1100 illustrated in FIGS. 11A-E. Among the functional components that can be included in the game simulation system 1300 are a photo mapper 1315, animation engine 1320, visibility detector 1325, special effects component 1330, collision detector 1335, game engine 1340, state manager 1345, and shot selector 1350. The game simulation system 1300 can share these functional components with the game system 1100 itself, or provide specialized versions of these and other components designed particularly for simulating the game play environment on the simulation system 1300. In some implementations, in lieu of utilizing production-quality course terrain and course photo files used by the game system 1100, the game simulation system 1300 utilizes terrain data 1355a, virtual photos 1355b, and masks 1355c from the virtual environment created by a pre-visualization system 1200.

Some functional components of the game simulation system 1300 can be partitioned in a client-server relationship between a local computing device corresponding to the system's user interface and one or more remote computing devices or servers. A communication module 1360 can be provided to allow communication between local and remote computing devices making up the game simulation system 1300. For example, in some implementations, virtual terrain data 1355a and virtual photo data 1355b may be provided on a local computing device together with the GUI 1305 and input 1310 modules. Additionally, a feedback component 1365 can also be provided locally for gathering user feedback of the simulation's performance. This local computing device can communicate through a local communication module with one or more servers providing the game play functionality (e.g., 1315, 1320, 1325, 1330, 1335, 1340, 1345, 1350).

Various implementations of the systems and techniques described in this specification can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used in this specification, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the subject matter have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method, comprising:
creating a 3D virtual environment by texture mapping one or more photographs of a physical environment onto a representation of the physical environment's 3D topography;
placing one or more virtual cameras in relation to the virtual environment so that each virtual camera's field of view captures a portion of the virtual environment;
presenting a first virtual camera's field of view;
accepting input to modify one or more parameters of the first virtual camera and updating the first virtual camera's field of view based on the modifying; and
generating a shot list for the physical environment based on the fields of view of the virtual cameras.

2. The method of claim 1 where placing the one or more virtual cameras comprises:
determining a camera density for one or more portions of the virtual environment; and
placing the virtual cameras according to the density.

3. The method of claim 1 where placing the one or more virtual cameras comprises:
determining hazard locations for one or more portions of the virtual environment; and
placing the virtual cameras based on the hazard locations.

4. The method of claim 1 where the virtual camera parameters include position, rotation, tilt, and field of view.

5. The method of claim 4, where the position comprises a GPS coordinate.

6. The method of claim 1, further comprising:
presenting an avatar or other visual indicator in the first virtual camera's field of view.

7. The method of claim 1, further comprising:
using the virtual environment in an interactive game.

8. The method of claim 1, further comprising:
accepting input to interactively modify one or more parameters of the virtual environment.

9. The method of claim 1 where each photograph is mapped to a portion of the representation of the physical environment's 3D topography that the photograph corresponds to.

10. The method of claim 1 where the photograph is an aerial photograph.

11. The method of claim 1 where the photograph is a stereo pair.

12. A computer-implemented method comprising:
creating a 3D virtual environment, where the virtual environment models a real-world environment;
placing one or more virtual cameras in relation to the virtual environment so that each virtual camera's field of view captures a portion of the virtual environment;
retrieving image data corresponding to each field of view; and
utilizing the image data in an interactive electronic game.

13. The method of claim 12 further comprising modifying one or more parameters of a first virtual camera and updating the first virtual camera's field of view based on the modifying.

14. The method of claim 13 where the one or more parameters of the first virtual camera are interactively modified prior to creating the image corresponding to the first virtual camera's field of view.

15. The method of claim 12 further comprising gathering feedback data corresponding to the presentation of image data as utilized in the interactive electronic game.

16. The method of claim 12 where the interactive game is a golf simulation game.

17. The method of claim 12 where image data defines at least one image.

18. The method of claim 17 where image data defining at least two adjacent images is processed so as to present the adjacent images as a single, contiguous image.

19. The method of claim 17 where the image data defines a plurality of images, the method further comprising selecting an image from the plurality of images to be presented based on one or more user inputs to the game and the state of the game.

20. The method of claim 19 where the state of the game is based on an interaction of a virtual object with a modeled physical characteristic of the real world environment.

21. The method of claim 17 further comprising enhancing an image by presenting at least one computer generated graphic concurrently with the image.

22. The method of claim 12 where a plurality of virtual cameras are placed in relation to the virtual environment, the virtual environment data corresponding to the fields of view of the plurality of virtual cameras defines a set of images, and where the image data integrated into a user interface defines a plurality of user interface views corresponding to the set of images.

23. A system comprising:
a user interface device;
a machine-readable storage device including a program product; and
one or more processors operable to execute the program product, interact with the display device, and perform operations comprising:
creating a 3D virtual environment by texture mapping one or more photographs of a physical environment onto a representation of the physical environment's 3D topography;
placing one or more virtual cameras in relation to the virtual environment so that each virtual camera's field of view captures a portion of the virtual environment;
presenting a first virtual camera's field of view;
accepting input to modify one or more parameters of the first virtual camera and updating the first virtual camera's field of view based on the modifying; and
generating a shot list for the physical environment based on the fields of view of the virtual cameras.

24. The system of claim 23 where the one or more processors comprise a server operable to interact with the user interface device through a data communication network, and the user interface device is operable to interact with the server as a client.

25. The system of claim 23 where the one or more processors comprises one personal computer, and the personal computer comprises the user interface device.

26. A system comprising:
a user interface device;
a machine-readable storage device including a program product; and
one or more processors operable to execute the program product, interact with the display device, and perform operations comprising:
creating a 3D virtual environment, where the virtual environment models a real-world environment;
placing one or more virtual cameras in relation to the virtual environment so that each virtual camera's field of view captures a portion of the virtual environment;
retrieving image data corresponding to each field of view; and
utilizing the image data in an interactive electronic game.

27. The system of claim 26 where the one or more processors comprise a server operable to interact with the user interface device through a data communication network, and the user interface device is operable to interact with the server as a client.

28. The system of claim 26 where the one or more processors comprises one personal computer, and the personal computer comprises the user interface device.

29. A computer program product, encoded on a computer-readable medium, operable to cause data processing apparatus to perform operations comprising:
creating a 3D virtual environment by texture mapping one or more photographs of a physical environment onto a representation of the physical environment's 3D topography;
placing one or more virtual cameras in relation to the virtual environment so that each virtual camera's field of view captures a portion of the virtual environment;
presenting a first virtual camera's field of view on a user interface;
accepting input to modify one or more parameters of the first virtual camera and updating the first virtual camera's field of view based on the modifying; and
generating a shot list for the physical environment based on the fields of view of the virtual cameras.

30. A computer program product, encoded on a computer-readable medium, operable to cause data processing apparatus to perform operations comprising:
creating a 3D virtual environment, where the virtual environment corresponds to a real-world environment;
placing one or more virtual cameras in relation to the virtual environment so that each virtual camera's field of view captures a portion of the virtual environment;
presenting a field of view for each virtual camera, each field of view capable of being viewed on a user interface;
retrieving virtual environment image data corresponding to the field of view of each virtual camera; and
uploading the image data to a game engine, where the image data is integrated into a user interface of a game driven by the game engine.
